(19) United States
(12) Patent Application Publication
(10) Pub. No.: US 2013/0212455 A1
(43) Pub. Date: Aug. 15, 2013

(54) System and Method for Examining the Financial Data of an Organization

(71) Applicants: William Roger Titera, Westlake, OH (US); Karl Joseph Busch, Concord Township, OH (US)

(72) Inventors: William Roger Titera, Westlake, OH (US); Karl Joseph Busch, Concord Township, OH (US)

(21) Appl. No.: 13/370,902

(22) Filed: Feb. 10, 2012

(51) Int. Cl. G06F 17/00

(52) U.S. Cl. 715/205; 715/212

(57) ABSTRACT

A system and method for presenting views into general ledger data of an organization is described. In some examples, the system presents a hierarchy of views that include information associated with journal entries of the general ledger data along with links to other views within the hierarchy.

### BACKGROUND

Various laws, regulations and/or contractual arrangements require an enterprise to present its financial position and results of operations regularly in the enterprise's financial statements. Some of those laws, regulations or contractual arrangements also require that those financial statements be audited, that management provide discussion and analysis of the financial position and results of operations, that management design, implement and assess the effectiveness of internal control over financial reporting, that an auditor's report on the enterprise's internal control over financial reporting be provided, etc.

To meet the aforementioned requirements, various persons such as the auditor, management, accounting personnel, internal audit, etc., generally need to review, analyze and test the financial data underlying the financial statements.

Because it is practically impossible to review all the data that comprise the financial records using conventional techniques and tools, generally only a small sample of the financial records is examined in order to gather the required information.

For example, during a typical financial statement audit, an organization provides an auditor with a set of financial statement data, including a trial balance, which aggregates to the financial statements. The trial balance is generally supported by raw financial data representing the general ledger (i.e., all journal entries of the organization) for the financial statements period. Using the raw data, an auditor may run various standard queries or tests against the data, possibly using the results of the queries to examine a small amount of transactions to review in greater detail.

Although virtually every organization uses software and other tools to manage and/or examine data, such as financial records, many conventional data management systems do not provide the comprehensive review of the general ledger and its journal entries or other financial data for purposes such as audit planning and/or execution.

For example, typical data management systems facilitate typical audit requests, and provide query-based or report-based reviews of general ledger data. Some of these query-based and/or report-based tools include AuditExchange by ACL and IDEA by Caseware International, which are tools for producing individual reports around specific queries, but do not solve the problems described herein with respect to typical audit procedures.

In fact, data management systems used internally by organizations may provide more useful information than the query-based or report-based tools often used for external audits. For example, Continuous Control Monitoring, Business Intelligence, Enterprise Resource Planning, or other data management systems enable an organization to internally review and/or test its financial records against various controls, but suffer from drawbacks similar to those of the query-based or report-based systems, such as limitations associated with viewing data within financial records, among other things.

While aforementioned systems are generally suitable for a particular purpose, such systems are not sufficiently suitable for the purpose discussed in the present invention. Thus, it is clear that there exists a need in the art for a system that overcomes these problems and progresses the state of the art, as well as one that provides the additional benefits enumerated in the present application.

### SUMMARY OF THE INVENTION

In view of the foregoing disadvantages inherent in the art, in accordance with a first preferred embodiment of the present invention, a system and method for presenting information associated with an organization's financial data, such as financial statement data, profile data, activity data, and so on, is described. The system receives, reviews, and/or extracts journal entry data that comprise the general ledger from an organization or any sub-set thereof, presents multiple, different views of the data along with links or other pointers to similar views, such as links to views of various subsets of the data. The system, therefore, presents a concise, easy to navigate, yet comprehensive view of the financial data of an organization for a variety of purposes, such as for use within an audit of the organization, among other benefits.

In some examples, the system presents a variety of different views of the financial data of an organization using a data view module, such as a hierarchy of views that present the financial data in varying levels of detail. For example, the system may receive a request to present a first, global view of the financial statements or other high-level view, and present information associated with the view along with a link or other pointer to a different view of the underlying financial data, such as a detailed view of a single transaction within the financial statements.

In accordance with alternative embodiments, the system provides a variety of entry point views into detailed information associated with general ledger data for an organization. The system may provide the financial statement view, a planning and/or profile view, an audit view, and so on, associated with general ledger data. Each of the entry point views may include nested or other views associated and linked together in a hierarchy. By providing these entry point views, the system enables an auditor or other financial data reviewer with access to the entire general ledger and its journal entries at various levels of granularity, among other things.

Therefore, in some examples, the system provides auditors or other users an entire set of general ledger data or any sub-set thereof, such as all related journal entries, accessible at various levels of detail and/or presentable for various different purposes. Thus, instead of relying exclusively on sampling or other conventional techniques, the system enables auditors or other financial data reviewers to access and/or review most or all transactions within a financial statement period of an organization at many different levels and from many different perspectives. In providing these views into the general ledger data, the system facilitates the access and/or review of detailed information, such as individual transactions, within a large set of general ledger data. By enabling access to individual transactions from a view of an entire data set, the system may provide additional benefits associated with requests for supporting information for a given transaction or selecting transactions to test and/or analyze, among other benefits.

Thus, by providing an auditor or other users with various views and/or entry points into an entire set or sub-set of general ledger data, the system provides a method for identification of unusual or higher risk areas or journal entries within the financial records of an organization, which can lead to more effective audits, better organizational efficiencies, optimized accounting procedures, better financial and board governance compliance, cost savings, and other benefits.

In addition to internal and external audits, the system, in some examples, may also incorporate views and link information in order to support general financial management review and reporting procedures, fraud detection systems, business process improvements, business metric analyses, or other processes that may benefit from a hierarchical organization of data having entry points at various levels of detail and with various perspectives.

Thus, there has been summarized and outlined, generally in broad form, a plurality of the most important features of the present invention. While this summary is presented so that the novelty of the present contribution to the related art may be better appreciated, it will further be apparent that additional features of the invention described hereinafter (which will form the subject matter of the claims appended hereto) will further define the scope, novelty, and in certain instances the improvements upon any existing art. The following description provides specific details for a thorough understanding of, and enabling description for, various examples of the technology. One skilled in the art will understand that the technology may be practiced without many of these details and it is to be readily understood that the invention presented herein is not limited in its application to the details of construction and to the arrangements of the components set forth in the following description or illustrated in the various some instances, well-known structures and functions have not been shown or described in detail to avoid unnecessarily obscuring the description of the examples of the technology. It is intended that the terminology used in the description presented below be interpreted in its broadest reasonable manner, even though it is being used in conjunction with a detailed description of certain examples of the technology. Although certain terms may be emphasized below, any terminology intended to be interpreted in any restricted manner will be overtly and specifically defined as such in this Detailed Description section. Those skilled in the art will appreciate that the disclosure of the present invention may readily be utilized as a basis for the designing of other similar structures, methods and systems for carrying out the various purposes and objectives of the present invention. Thus, the claims as set forth shall allow for such equivalent constructions insofar as they do not depart from the spirit and scope of the present invention as described herein.

### BRIEF DESCRIPTION OF THE FIGURES OF THE PRESENT INVENTION

A further understanding of the present invention and the objectives other than those set forth above can be obtained by reference to the various embodiments set forth in the illustrations of the accompanying figures. Although the illustrated embodiments are merely exemplary of the present invention, apparatus and method of use of the invention, in general, together with further objectives and advantages thereof, may be more easily understood by reference to the drawings, examples, and the following description. The examples and figures are not intended to limit the scope of this invention, which is set forth with particularity in the claims as appended or as subsequently amended, but merely to clarify and exemplify the invention. The detailed description makes reference to the accompanying figures wherein:

FIG. 1 is a block diagram illustrating a suitable computing environment in which aspects of the technology may be implemented.

FIG. 2 is a block diagram illustrating the components of the data view module.

FIG. 3 is a flow diagram illustrating a routine for presenting a selected view of the financial data of an organization.

FIG. 4 is a block diagram illustrating a view hierarchy of the financial data of an organization provided by the data view module.

FIG. 5 is a display diagram illustrating a data view page that presents multiple, selectable views of financial data within an organization.

### DETAILED DESCRIPTION OF THE PRESENT INVENTION

A detailed illustrative embodiment of the present invention is disclosed herein. However, techniques of implementation and resulting structures in accordance with the present invention may be embodied in a wide variety of forms and modes, some of which may be quite different from those in the disclosed embodiment. Consequently, the specific structural details disclosed herein are merely representative, yet in that regard, they are deemed to afford the best embodiment for purposes of disclosure and to provide a basis for the claims herein, which define the scope of the present invention. The following presents a detailed description of several examples of the present invention.

Moreover, well known methods, procedures, and substances for both carrying out the objectives of the present invention and illustrating the preferred embodiment are incorporated herein but have not been described in detail as not to unnecessarily obscure novel aspects of the present invention.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

Suitable Computing Environment

As described herein, a data view system presents views of general ledger information, such as journal entries, using a data view module that communicates with general ledger data stored in a database associated with an organization, such as a business, company, non-profit organization, and so on.

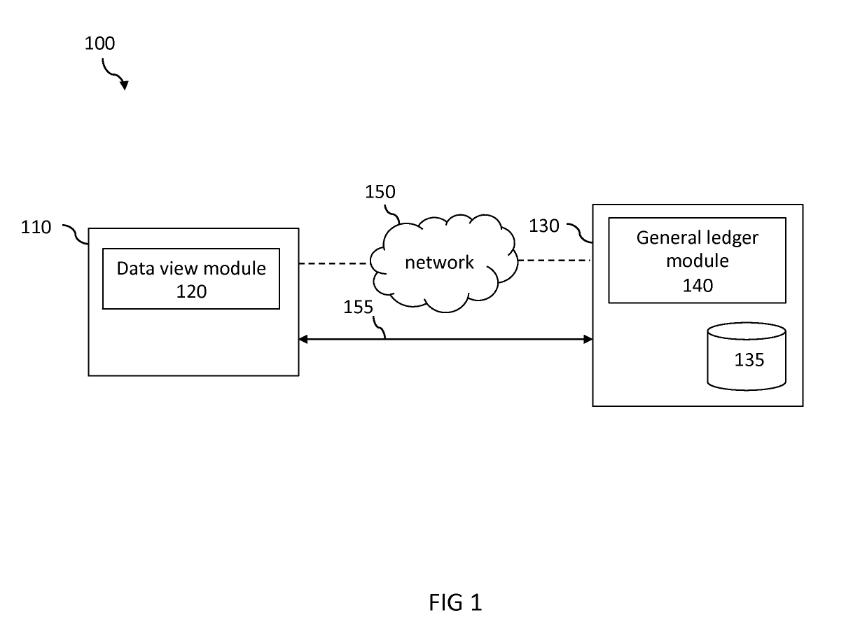

Turning to FIG. 1, a block diagram illustrating a suitable computing environment 100 in which aspects of the data view system may be implemented is shown. Although not required, aspects of the system are described in the general context of computer-executable instructions, such as routines executed by a general-purpose computer, e.g., a server computer, wireless device or personal computer. Those skilled in the relevant art will appreciate that the system can be practiced with other communications, data processing, or computer system configurations, including: Internet appliances, network PCs, mini-computers, mainframe computers, tablet computers, mobile devices, and the like. Indeed, the terms “computer,” “host,” and “host computer” are generally used interchangeably herein, and refer to any of the above devices and systems, as well as any data processor.

Aspects of the system can be embodied in a special purpose computer or data processor that is specifically programmed, configured, or constructed to perform one or more of the computer-executable instructions explained in detail herein. Aspects of the system can also be practiced in distributed computing environments where tasks or modules are performed by remote processing devices, which are linked through a communications network, such as a Local Area Network (LAN), Wide Area Network (WAN), Storage Area Network (SAN), Fibre Channel, or the Internet. In a distributed computing environment, program modules may be located in both local and remote memory storage devices.

Aspects of the system may be stored or distributed on computer-readable media, including magnetically or optically readable computer discs, hard-wired or preprogrammed chips (e.g., EEPROM semiconductor chips), nanotechnology memory, biological memory, or other tangible data storage media. Indeed, computer implemented instructions, data structures, screen displays, and other data under aspects of the system may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the system reside on a laptop, desktop, or server computer, while corresponding portions may reside on a client computer, and thus, while certain hardware platforms are described herein, aspects of the system are equally applicable to nodes on a network.

The computing environment 100 includes a data view server 110 or other computing system that contains a data view module 120 that includes components configured and/or programmed to receive and/or review general ledger data stored in a general ledger module 140 within a server 130 having various databases 135 of data associated with an organization.

For example, the data view server 110 may provide the information to and/or include a tablet computer or laptop computer of an auditor, which supports a program or other computing module provided by the data view module 120 that presents the various views of the general ledger data described herein via associated displays or other user interfaces.

In some embodiments of the present invention, the data view module 120 is a spreadsheet application, or a storage device that stores a spreadsheet application and associated databases. For example, the data view module 120 may be a Microsoft Excel Spreadsheet application, an Apple Numbers application, a GNUMERIC or other open source spreadsheet application, a web-based spreadsheet application, a customized application, or any other application capable of and configured to provide cell and sheet based computing functions as well as maps and other visual views associated with information stored and/or accessed by the application.

In some embodiments of the present invention, the general ledger module 140 stores or accesses financial data stored in a database and associated with an organization, such as a business or corporation. The general ledger module 140 may provide financial data, such as general ledger data, to the data view module 120. For example, the general ledger module 140 may provide raw data associated with every transaction performed by an organization, as well as data sets grouped by categories, such as assets, liabilities, equity, revenue, expenses, gains, and/or losses. That is, the general ledger module 140 can include and/or provide data and associated information for transactions performed during a period of time under audit, such as a year of transactions being audited.

Although shown as one component, the general ledger module 140 may include multiple components located at different locations within an organization, such as multiple storage devices within a storage area network (SAN) or other networked data storage system within an organization.

The data view module 120 may communicate with the general ledger module 140 in order to receive and/or extract data from the general ledger module 140 in a variety of ways, such as via a direct connection 155 or via a networked connection 150, such as over a networked connection that supports internet protocol (IP) data communications. For example, the data view module 120 may be hosted by a server at an auditor's office and communicate with a remote server associated with an organization over an internet connection, often using a secure or private communications link, in order to access financial data contained by the general ledger module 140.

Presenting Views of Financial Data

As described herein, a first preferred embodiment of the present invention includes a data view module 120 that presents an organization's financial data using different views of the data along with links or other pointers to similar views, such as links to views of various subsets of the data. In some embodiments of the present invention, the data view module 120 is an Excel-based application that provides views into an organization's financial data and associated activities that affect the financial data. The data view module 120 may provide views associated with financial statements and associated detailed information (e.g., balance sheet, income statement, lead sheets, key items, tie-outs, and so on), views associated with the planning or profile of an organization (e.g., maps relating to financial statement captions journal entry sources or income trends by source, and so on), views associated with tests or analyses performed (e.g., date-based tests of financial statement accounts, tests that analyze transactions satisfying certain criteria, and so on), and/or other views into a general set of financial data.

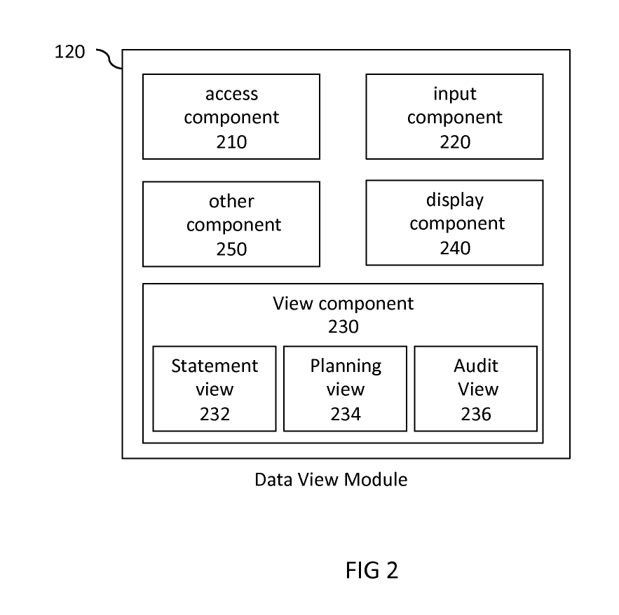

FIG. 2 depicts a block diagram illustrating the hardware and/or software components of the data view module 120. The data view component 120 includes an access component 210 configured and/or programmed to access or receive data stored in a general ledger module 140 associated with an organization, an input component 220 configured and/or programmed to received and respond to input (e.g., the selection of a specific financial statement caption) received from a user of the data view module 120, and a display component 240 configured and/or programmed to render and/or display information to a user, such as within a spreadsheet view, as a map of information, as a selectable view of information, and so on.

The data view module 120 also includes a view component 230 configured and/or programmed to present a variety of different views of the financial data of an organization. The view component 230 may include a statement view component 232 configured and/or programmed to provide a view associated with financial statements for an organization, a planning view component 234 configured and/or programmed to provide a view associated with planning or profile information for an organization, and an audit view component 236 configured and/or programmed to provide a view associated with audits or other reviews of the financial data of an organization. Of course, one of ordinary skill in the art will realize that the view component 230 may include other components that provide various perspective views into the financial data of an organization, such as user-customizable or user-set views, saved or historical views, views that provide information associated with fraud detection, views that provide information associated with business processes, views that provide information associated with material or other key areas within a financial record, and so on.

The view component 230 may generate a hierarchy of views into the general ledger data of an organization, and present these views as pages or worksheets within a displayed version of the data view module 120. That is, in some embodiments of the present invention, the view component 230 provides the display component 250 with information that links various pages to one another, where each page provides a different, or more granular, view into the financial data of an organization.

In order to facilitate access to the financial data at various entry points and/or perspectives, among other reasons, the view component 230 may establish a hierarchy of nested views into the financial data of an organization. That is, each specific or individual view may be represented by a page that provides information associated with the individual view along with a link or pointer to a page associated with or nested to that page, such as a page associated with a data subset of the original page.

The data view module 120 may include other components 250 that facilitate the access of financial information as various views into the financial data of an organization. For example, the data view module 120 may include components that provide organizational or user information, storage components, components that provide contextual information or metadata, components that generate reports, charts and other documentation, components that transfer data or other information to associated computing systems, such as other accounting or financial management systems, components that provide security or other credentialing techniques to users of the module, and so on.

Thus, in some embodiments of the present invention, the data view module 120 includes components configured and/or programmed to generate and present various different views into data within a general ledger module 140 and/or database 135 of an organization. The data view module may perform various processes, methods, routines, and/or techniques, some of which are described in detail herein.

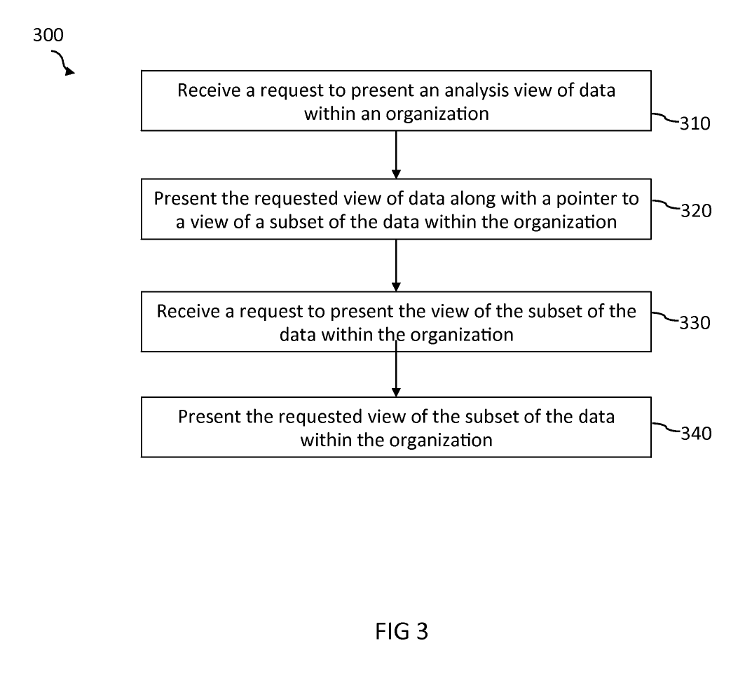

FIG. 3 is a flow diagram illustrating a routine 300 for presenting a selected view of the financial data of an organization.

In step 310, the system receives a request to present an analysis view of financial data within an organization. For example, the system, presented as a spreadsheet application by the data view module 120, receives a request, via the input component 220 of the data view module 120, from a user, such as an auditor, to present a specific view into the general ledger data of an organization.

In some cases, the request is received by the system as a user selection of a view presented by the display component 220 of the data view module 120 as a display page, sheet, or screen that includes links or pointers represented by graphically displayed elements. The system may receive the request via a main page that provides links to general or high-level views of financial data, a view page that includes information for a specific view along with a pointer to associated data presented by another, possibly narrower view, or via other points of entry provided by the system. That is, the system may receive the request while presenting high-level information (e.g., financial statement or activity statement information), low-level information (e.g., journal entry details or individual transaction information), and various points in between.

In step 320, the system presents the requested view of data along with a pointer to a view of a subset of the data within the organization. For example, the system, via the display component 220 of the data view module 120, presents a view of requested information as a page or sheet along with a link or other navigation aid to other views into the financial data of an organization, such as a view of a subset of the information displayed by the page, a view of information associated with a certain perspective into the financial data, and so on.

The system may present a variety of different high-level and detailed views into the financial data (e.g. general ledger data) of an organization, such as:

Financial statements, such as balance sheets or income statements;

Expanded Financial Statement Captions, which may present information associated with individual general ledger account balances and changes;

Lead sheets, such as standard audit lead sheets;

Activity Sheets, possibly correlated by source and providing trended details of a particular account(s);

Key Items selected over an amount, such as a user-entered amount;

Process Maps, Preparer Maps, Business Unit (BU) Maps, and other maps that provide and/or relate organization profile and/or activity information to financial information;

Trending Data Views, such as views that present account trending, source trending, preparer trending, BU trending, and so on;

Various analyses, such as income analyses, gross margin analyses, date analyses, timing analyses (e.g., day of the week, lags between entry and effective dates, near period ends, and so on);

Correlation information, such as two-way or three-way correlation information;

Filtered Journal Entries;

Line Items;

Journal Entry summaries and Journal Entry details; and so on.

In step 330, the system receives a request to present a selected view of a subset of the data within the organization. For example, the system, via the input component 210 of the data view module 120, receives a selection of the link or pointer presented by the current view of the financial data.

Although the system, via the data view module 120, facilitates and/or enables navigation between any available views to any other available view, the system may, in some cases, provide links that follow or enable certain logical, frequent, or often-used movement between views of financial data.

For example, the view component 230 of the data view module 120 may provide a Lead Sheet view that includes information associated with one or more Lead Sheets (e.g., account information) along with hyperlinks to account activity sheets.

As another example, the view component 230 of the data view module 120 may provide a view of an Income Analysis of the financial data along with hyperlinks to views of various line items of the income analysis, and the views of the various line items of the income analysis may include hyperlinks to views of various journal entries for each of the line items.

The system may create, render, and/or generate various pages, screens or sheets upon receiving a selection of a link to a specific view of the financial data of an organization. For example, the system, via the display component 240 of the data view module 120, may generate a page associated with a view to a specific line item for a transaction only upon receiving a selection of the specific line item. In order to facilitate the dynamic creation of various pages in response to user selections, the data view module 120 may include access to various template pages or sheets, and create a page for a user by updating, modifying, or otherwise configuring a template page with information associated with financial data for a selected view of the data. Of course, in some cases, the system may first prepare or otherwise render all pages or sheets available for selection by a user.

Referring back to FIG. 3, in response to the request to present the view of the subset of the data within the organization received in step 330, the system, in step 340, presents the requested view of the subset of the data within the organization. For example, the system, via the display component 240 of the data view module 120, presents a second view of the financial data of the organization, such as a page that includes information representing a subset of data within the entire general ledger data set. (e.g., An Account Activity view or Lead Sheet for the selected financial statement caption link.)

As described herein, in some embodiments, the system presents a number of different views into the financial data of an organization, such as views that provide high-level information, views that provide transaction-level detailed information, and so on. Furthermore, the system provides a hierarchy of views that enables a user to navigate between views, among other benefits.

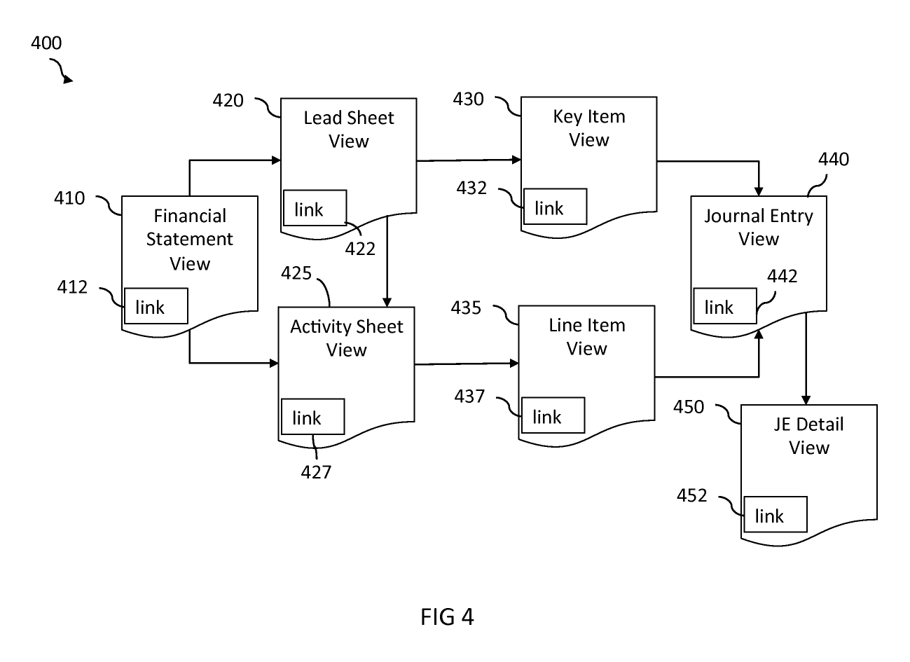

FIG. 4 depicts a view hierarchy 400 of the financial data of an organization provided by the data view module 120. The hierarchy 400 includes a financial statement view 410 or other high-level views, which includes links 412 to next-level views, such as a Lead Sheet view 420 and/or an Activity Sheet view 425. The financial statement view 410 may include high-level information, such as:

Balance Sheet Information, including trial balance data that has been mapped to the financial statement caption for the balance sheet accounts for a current and prior time period. A “Change” column shows the fluctuations for a defined audit period by amount and percentage for each financial statement caption; and/or

Income Statement Information, including trial balance data that has been mapped to the financial statement captions for the income statement accounts for a current and prior time period. A “Change” column shows the fluctuations for the defined audit period by amount and percentage for each financial statement caption. A “Common Dollar” column shows the percent of total revenue for each Expense FS Caption; or other high-level information.

In some cases, following a link 412 from the financial statement view 410, the system presents the Lead Sheet view 420 of the financial data. The Lead Sheet view 420 may include various types of information, such as the general ledger account number, name, beginning and ending balances for the general ledger account, and/or currency and percent changes in the period, along with one or more links 422 to other views, such as a link to the Activity Sheet view 425, a link to a Key Item view 430, and so on.

In some instances, following the link 422 from the Lead Sheet view 420, the system presents the Key Item view 430 of the financial data. The Key Item view 430 may include information for all individual key items over a specified amount for a general ledger account or a financial statement caption, among other information, along with links 432 to one or more Journal Entry views 440 of the financial data.

The system may present the Activity Sheet view 425 of the financial data in response to a selection of a link 412 presented by the financial statement view 410, a selection of a link 422 of the Lead Sheet view 420, or a selection of links presented by other views of the financial data.

The Activity Sheet view 425 may include an account activity worksheet that displays information about the activity from one or more general ledger accounts or financial statement captions, along with links to a line item view 435 of the financial data.

The account activity worksheet presented by the Activity Sheet view 425 may include a number of different tables, maps and/or other presentable information displays, such as:

An Account Rollforward table for the general ledger account that displays the provided beginning balance for the selected accounts on the first row and then summarizes all of the activity posted for the selected accounts for the entire audit period, broken apart by source. Expanding a source (e.g. selecting a view of the source) will show the “other side” of all journal entries from that source that had the selected general ledger account(s) or financial statement (FS) Caption contained in the transaction. The other side is a summary of the debit amount, credit amount and total amount by FS Caption for all the other lines in the journal entries that contained the selected account(s). This gives the user a sense of the types of entries that were recorded from this source and contained the selected account(s);

An Account Activity table that lists the general ledger account(s) that were selected or that are part of the selected FS Captions and the corresponding amounts by effective month or period, including a running monthly balance for the selected general ledger account(s) or FS Caption(s);

A Source Activity table that displays the same total amount of activity per month/period as in the Account Activity table, detailed by the source field. Each row of the table displays one of the sources that comprise the selected accounts' activity;

A Process Map or view that shows each source of general ledger entries as column headers and the FS Captions as row headers. At the intersection of the Source and FS Caption is the total activity for the entire period being audited. The current year balance and prior year balance are also displayed for each FS Caption;

A Preparer Map or BU Map, the same as the Process Map, that shows Preparer ID or Business Unit values instead of Source values as the column headers;

Source Trending (Preparer Trending or BU Trending) information. For example, clicking on the column header for a source in the Process Map displays a worksheet with all the activity from the selected source trended month to month by FS Caption. From the Preparer Map, clicking a Preparer ID column header will trend all the activity from the selected Preparer month to month by FS Caption. From the BU Map, clicking a Business Unit column header will trend all the activity from the selected Business Unit month to month by FS Caption;

An Income Analysis worksheet that displays the income for the client month to month throughout the audit period. A line graph shows the total income recorded each month while bar graphs show the total revenue and total expenses month to month. The Income Analysis then displays the details of the graph below in a tabular format. One table shows the FS Captions that are part of revenue trended month to month. A second table shows the FS Captions that are part of expenses trended month to month. A third table shows the total income number trended month to month. The Income Analysis also breaks down the income by source. A clustered bar graph shows each month of income by each source. For example, the first group of bars shows the sales system with a bar for January, another for February and so on through December. A table below the graph displays all of the numbers behind each value in the graph;

A gross margin table presents the sales compared to the cost of sales in table and graph formats. The user selects the FS Caption(s) or general ledger Accounts that represent “Sales” and the FS Caption(s) or general ledger Accounts that represent “Cost of Sales”. The sheet created shows all of the activity for each GL Account in sales trended month to month and all of the activity for GL Account in cost of sales trended month to month. The total activity for each group of accounts is used to compute a gross margin month to month in dollars and percentages. A graph is also created showing the gross margin percentage trended month to month along with total sales as a bar, split into a section for cost of sales and a section for gross margin;

A Date Analysis that creates three worksheets focused on analyzing the timing of journal entries containing one or more selected FS Captions or general ledger accounts. A Day of the Week worksheet includes a table showing the days of the week and total debits, total credits and net amount on each day for the line items matching the selected FS Caption(s) or general ledger Account(s). A Day Lag worksheet provides a summary of the days between entry and effective dates. This allows the user to compare the date when journal entries were entered compared to when they became effective. For example, line items with the same entry and effective date display a difference of “0” days; if the effective date is one day before the entry date, these line items are displayed with a difference of “−1” days. The Date Analysis Day Lag worksheet provides a summary of the days between entry and effective dates. This allows the user to compare the date when journal entries were entered compared to when they became effective. For example, line items with the same entry and effective date display a difference of “0” days; if the effective date is one day before the entry date, these line items are displayed with a difference of “−1” days. A Day of the Month worksheet displays all of the activity for the selected FS Caption(s) or general ledger account(s) in a cross-tab style view. The Effective Date Month is the column header and the Effective Date Day is the row header. This view allows the auditor to review entries posted at the beginning or end of the months or to spot trends. A table below the cross-tab calculates the monthly average and 2 standard deviations above or below the average. Amounts for each day of the month that are outside the 2 standard deviation range for the given month are highlighted to show those days that are unusually high or low for that month. The auditor can also click a link on the sheet to create the same view for only credit amounts or only debit amounts;

A Near Period End table that allows the user to focus on information generated near the end of a period. It summarizes journal entries that were entered in the selected time period and shows the activity day by day. The auditor selects one or more FS Captions or General Ledger Accounts, selects the period end date they are interested in focusing on and the number of days prior to the end of the period. The results are displayed by FS Caption and entry date for the entire journal entries matching the criteria.

A Fixed Asset analysis that provides analysis tools for property, plant, and equipment (PPE). The PPE analysis creates the following worksheets:
1. A PPE Summary that shows the beginning and ending balances, with subtotals and net shown between the columns;
2. A PPE Lead Sheet that is a standard lead sheet with variations for PP&E, where accounts are grouped according to the mappings and show subtotals for those groups of accounts. The lead sheet shows the GL account number, name, beginning and ending balances for the GL account, and currency and percent changes in the period;
3. A PPE Trending that shows month-by-month activity, grouped by asset activity, accumulated depreciation activity, and depreciation expense activity; and
4. A PPE Additions and Disposals that displays the journal entries for each transaction over the threshold amount;
5. A depreciation analysis that is a summary of the depreciation, with lines that allow the user to enter comparison values from the policy;

A Two-way correlation analysis that looks for an expected relationship between two sets of accounts within the same transaction and profiles those transactions. An example would be a journal entry to record product sales. In a transaction such as this, in many businesses it would be expected to have two primary components: Sales and Accounts Receivable. For descriptive purposes, in this example the Sales accounts are the primary portion of the correlation, while the Accounts Receivable accounts are the secondary portion. Two worksheets are created. The activity that is posted to the primary group of accounts and were in journal entries also containing the second group of accounts are shown in the Correlation Analysis worksheet with two main parts:
1. To illustrate the correlating portions of the transactions, a line graph is displayed trending two lines with the cumulative amounts of both the primary and secondary accounts month to month. If the journal entries are meeting the auditor's expectations, then the two lines should be trending in a similar fashion and not deviating significantly. The correlating amounts are also displayed in two tables, one for the primary group and one for the secondary, to show the activity by Source trended month to month. Each Source that was recorded is displayed as a row header with the activity from the source displayed month to month; and
2. A summary of all of the journal entries containing the two selected groups of FS Captions or GL Accounts. It shows the journal entries summarized by FS Caption trended month to month;

The activity that is posted to the primary group of accounts that was in journal entries not containing the secondary group of accounts is profiled in the Remaining Activity worksheet;

Journal entries with the primary portion and no accounts from the secondary portion that are summarized by FS Captions and trended month to month. The auditor can review these items as they may be of higher risk or they can assist the auditor in learning more about the way the client records its financial transactions;

The activity from the remaining primary accounts that is also displayed trended month to month by source;

The 3-way correlation that builds on the concept of the 2-way correlation and “joins” two 2-way correlations together. This analysis is a tool for reviewing the journal entries of three accounts that are expected to have predictable relationships. For example, if an activity, such as sales, correlates with other accounts, such as accounts receivable and expected subsequent cash collections, the user can use 3-way correlation to analyze sales activity relative to subsequent cash collections. 3-way correlation creates two 2-way correlations and the 4 sheets that accompany those, such as Sales-AR correlation, Sales Remaining Activity, AR-Cash Correlation and AR Remaining Activity;

A new sheet that displays the “Leftover” portion of the joining group that was not contained in the first correlation or the second correlation. For example, the AR activity that was not related to Cash and was not part of the Sales-AR Correlation;

A summary sheet that profiles all 3 groups of accounts. The summary shows a roll-forward of the joining group (e.g., Accounts Receivable), starting with the beginning balance, displaying all of the activity and which portion of the correlations it was attributed to (e.g., Sales-related, Leftover) and comparing this rolled forward balance to the actual ending balance. Clicking any of the values from the correlations will navigate the auditor to the relevant sheet within the correlations. The summary also shows a graph with the joining account's balance trended month to month as a line and the activity amounts from each component of the correlations as bars for the activity associated to each month. For example, the graph begins with the Dec. 31, 2009 balance and shows how it changes month to month; then the activity for each month is shown with a bar for AR attributed to Sales, a bar for AR attributed to Cash Collections and a bar for Other AR activity, which explains the change in balance for each month;

A filter journal entry view that summarizes all journal entries and shows the impact to the financial statement captions trended month-to-month for FS Captions or GL Accounts the auditor selected. Filter JE's can be used to analyze any account or group of accounts, but a common use is to review how estimation accounts are used; and so on.

Referring back to FIG. 4, the Activity Sheet view 425 may include, in addition to the numerous worksheets, tables and other information described herein, links 427 to a Line Item view 435 of the financial data.

Following a link 427, the Line Item view 435 displays all of the fields from the line items contained in the subset of financial data represented by the link that was selected. The Line Item view presents a summary of an entire journal entry that the line item is a part of or to which it refers and/or links. There may be grouped columns that summarize the entire journal entry at the Assets, Liabilities, Equity, Revenue and Expenses level. The auditor can see the impact of the entire journal entry on the financial statements at that level or they can expand one of those columns to see the FS Captions. In addition to the link 427 from the Activity Sheet view 425 and the Line Item view 435, the system may provide a link to the Line Item view 435 from most or all of the views presented by the data view module 120.

In response to a selection of link 432 or link 437, the system presents a Journal Entry view 440 of the financial data that includes Journal Entry Summary information along with a link 442 to a Journal Entry detail view 450. The Journal Entry information may include a summary of a single, entire journal entry. The summary displays the net impact of the journal entry on the financial statements. Each row displays the JE Number, one of the FS Captions involved in the journal entry with a column each for the net activity, debit activity, credit activity and count of line items. A Journal Entry Summary may summarize a journal entry that may be 100 or more lines down to see the impact of that journal entry in a couple of lines of displayed text.

In response to a selection of link 442, the system may present the Journal Entry Detail view 450 of the financial data, which may include line item details for a specific Journal Entry. Of course, one of ordinary skill in the art will appreciate that the data view module 120, or other components or modules of the system, may present other views not shown in the view hierarchy 400 or described herein.

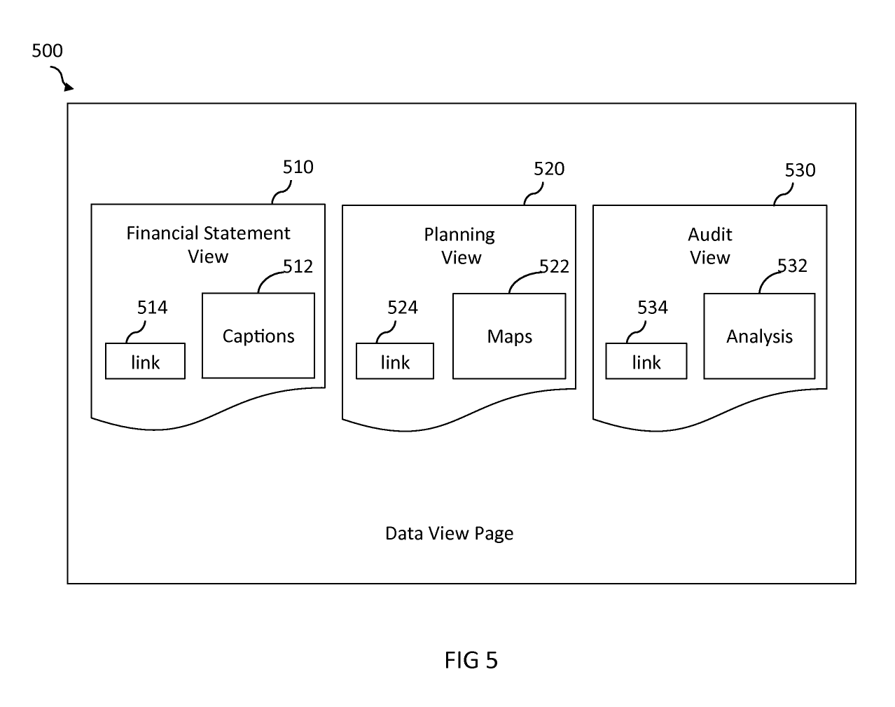

As described herein, in some embodiments of the present invention, the system, via the data view module 120, presents a variety of perspective views of the financial data of an organization. FIG. 5 depicts a data view page 500 that presents multiple, selectable views of financial data within an organization.

In some embodiments, the data view page 500 includes a financial statement view 510 that includes FS caption information 512 and other related information along with a link 514 to other views of the financial data, as illustrated in FIG. 4. The FS caption information 512 may include a view into an organization's financial statement, with links into any Financial Statement (FS) Captions or general ledger accounts, standard audit lead sheets, select key items, and so on, and may perform financial statement tie-outs or other actions.

In some embodiments, the data view page 500 includes a planning view 520 that includes profile information 522 and other related information along with a link 524 to other views of the financial data. The profile information 522 may include a view of organization profile information, such as maps that show the total effect a journal entry source (or user or business unit) has on each FS Caption, or income trended month to month with a breakdown of all sources of income, among other things.

In some embodiments, the data view page includes an audit view 530 that includes audit analysis information 532 and other related information along with a link 534 to other views of the financial data. The audit analysis information 532 may include information generated to assist in standard audit procedures. For example, the information may include the results of a Date-based analysis of any FS caption(s) or accounts, graphically trended ratio analysis, correlate all transactions with certain pairs of accounts included, show the effect of all transactions matching certain criteria on the client's financial statements over the course of the audit period, and create other standard schedules previously prepared by the organization, among other things.

Of course, one of ordinary skill in the art will appreciate that the system may present other perspective views via the data view page 500, such as one or more of the views described herein.

Thus, in some examples, the system facilitates a more informed audit by reducing risk and creating higher value and improved insight into an organization and its business over conventional audit procedures and tools. By effectively utilizing an entire general ledger data set including related journal entries, the system may reduce the time and effort spent by an organization during an audit, such as time spent providing audit schedules to the auditor, follow up information, and so on.

The system, therefore, enables an auditor to perform a complete, detailed, and comprehensive review of an organization's financial data, among other benefits, by presenting the auditor with a tool that associates various views, with respect to level of detail or perspective, of the financial data along with links to the different views.

While certain aspects of the system are presented below in certain claim forms, the inventor contemplates the various aspects of the system in any number of claim forms. Accordingly, the inventor reserves the right to add additional claims after filing the application to pursue such additional claim forms for other aspects of the system.

I claim:

1. A system for presenting a graphical view of general ledger data associated with an organization, the system comprising:
an access component, wherein the access component is configured to access general ledger data stored in a database associated with the organization; and
a view presentation component, wherein the view presentation component is configured to present multiple views of the general ledger data accessed by the access component;
wherein at least one of the multiple views of the general ledger data includes information associated with the view and a link to another view presented by the view presentation component; and
wherein the view presentation component is a spreadsheet application stored in memory of a computing system that displays the multiple views of the general ledger data to a user via a display associated with the computing system.

2. The system of claim 1, wherein the view presentation component is further configured to at least present a financial statement view, a lead sheet view, an activity sheet view, a key item view, a line item view, a journal entry view, and a journal entry detail view of the general ledger data.

3. The system of claim 1, wherein the view presentation component is further configured to at least present a summary view of multiple transactions within the general ledger data and an individual view of a single transaction within the general ledger data; and wherein the summary view of the multiple transactions within the general ledger data includes a link to the individual view of the single transactions within the general ledger data.

4. The system of claim 1, wherein the view presentation component is further configured to at least present a financial statement view, a planning view, and an audit analysis view of the general ledger data.

5. The system of claim 1, wherein the view presentation component is further configured to present multiple views organized as a hierarchy of pages that display information associated with the general ledger data along with a link to another page within the hierarchy of pages.

6. The system of claim 1, wherein the view presentation component is further configured to present multiple views organized as a hierarchy of pages that display information associated with the general ledger data.

7. The system of claim 1, wherein the view presentation component is further configured to present multiple views organized as a hierarchy of pages that display information associated with the general ledger data along with a link to a nested page within the hierarchy of pages.

8. The system of claim 1, wherein the access component is configured to access general ledger data stored at two or more locations within the organization.

9. The system of claim 1, wherein the access component is configured to access raw general ledger data stored in one or more databases within the organization.

10. A method performed by a computing system for graphically providing a view of general ledger data for an organization, the method comprising:
receiving a selection of a financial statement associated with the general ledger data;
presenting a view of information contained by the financial statement along with a pointer to a sheet level view of information within the financial statement; and
in response to a selection of the pointer, presenting the sheet level view of information within the financial statement.

11. The method of claim 10, wherein presenting a sheet level view of information includes presenting a pointer to an item level view of information, the method further comprising:
receiving a selection of the pointer to the item level view of information;
generating the item level view of information using an item level view template.

12. The method of claim 10, wherein presenting a sheet level view of information includes presenting a pointer to an item level view of information, the method further comprising:
receiving a selection of the pointer to the item level view of information;
generating the item level view of information using an item level view template, wherein the generated item level view of information includes a pointer to a journal entry summary view of information associated with an item presented by the item level view of information;
receiving a selection of the pointer to the journal entry summary view of information; and
presenting a journal entry summary view of information in response to the received selection.

13. The method of claim 10, wherein presenting the sheet level view of information within the financial statement includes presenting a lead sheet view of the general ledger data.

14. The method of claim 10, wherein presenting the sheet level view of information within the financial statement includes presenting an activity sheet view of the general ledger data.

15. The method of claim 10, wherein presenting a view of information contained by the financial statement along with a pointer to a sheet level view of information within the financial statement includes presenting a first pointer to a lead sheet view of information and a second pointer to an activity sheet view of information.

16. The method of claim 10, wherein presenting a view of information contained by the financial statement along with a pointer to a sheet level view of information within the financial statement includes presenting a first pointer to a sheet-level view of information and a second pointer to an item-level view of information.

17. The method of claim 10, wherein presenting a view of information contained by the financial statement along with a pointer to a sheet level view of information within the financial statement includes presenting a first pointer to a sheet-level view of information and a second pointer to a journal entry view of information.

18. A system stored in memory of a computing device for presenting multiple views of financial data of an organization, the system comprising:
a statement view component, wherein the statement view component is configured to access financial data stored at a server of an organization and present a financial statement view of the data via a display of the computing device;
a risk assessment view component, wherein the risk assessment view component is configured to access financial data stored at the server of an organization and present a profile view of the data via the display of the computing device; and
a financial analysis view component, wherein the financial analysis view component is configured to access financial data stored at the server of an organization and present an analysis view of the data via the display of the computing device.

19. The system of claim 18, wherein the financial statement view, the profile view, or the analysis view includes a link to a different view of the multiple views of the financial data of the organization.
